(19) United States
(12) Patent Application Publication
(10) Pub. No.: US 2004/0159515 A1
(43) Pub. Date: Aug. 19, 2004

(54) Coil over shock absorber with spring seat load adjusted damping

(76) Inventors: Stephen H. Bell, Guelph (CA); James M. Barbison, Brampton (CA); Kevin H. Erickson, Etobicoke (CA); Arnett R. Weber, Mississauga (CA); Ronald W. Farewell, Mississauga (CA); Richard Coury, Rochester Hills, MI (US); Thomas R. King, Milton (CA); Nelson C. Goncalves, Mississauga (CA)

Correspondence Address: CARLSON, GASKEY & OLDS, P.C., 400 WEST MAPLE ROAD, SUITE 350, BIRMINGHAM, MI, 48009, US

(21) Appl. No.: 10/369,895

(22) Filed: Feb. 19, 2003

(51) Int. Cl. F16F 9/00

(52) U.S. Cl. 188/315

(57) ABSTRACT

A coil spring over shock absorber assembly includes a dampening mechanism for varying a dampening rate. The coil spring mounted to the outside of the shock absorber includes an adjustable support to change spring preload in order to adjust for vehicle load and maintain vehicle ride height. A load sensor is positioned on one of the coil spring supports and communicates changes in the coil spring preload to a controller. The controller in turn adjusts a dampening mechanism disposed within the shock absorber to optimize the dampening rate of the shock absorber relative to the coil spring preload.

### BACKGROUND OF THE INVENTION

This invention relates to a coil over shock absorber assembly and method of operating a coil over shock absorber assembly including a dampening rate variable in response to changes in coil spring preload.

Typically, a shock absorber includes a hollow cylinder defining an internal chamber divided into two compartments by a piston assembly. Attached to the piston assembly is a rod that extends from the hollow cylinder. Regulating flow between the two chambers separated by the piston provides variable dampening. A conventional method of regulating fluid flow between the chambers includes proportionally opening a variable orifice. Changes in orifice size proportionally regulate the dampening characteristics of the shock absorber.

Another known means of varying the dampening rate of a shock absorber includes applying an electric field on an electro-reactive fluid to change fluid viscosity and thereby the dampening properties of the shock absorber. Typically, the piston or another assembly within the shock absorber includes a coil energized in proportion to the desired dampening properties.

A coil over shock absorber includes a coil spring mounted to the outside of the shock absorber. The coil spring and shock absorber are matched to provide desired height and dampening characteristics. Changes in coil spring preload require a corresponding change in the dampening characteristics of the shock absorber to maintain an optimal combination of spring force to dampening rate.

Accordingly, it is desirable to develop a coil over shock absorber assembly that automatically varies the dampening rate in response to variations in coil spring preload.

### SUMMARY OF THE INVENTION

An embodiment of this invention is a shock absorber assembly including a variable dampening mechanism that is variable in response to changes in coil spring preload.

The shock absorber includes a variable dampening mechanism that provides a dampening rate specifically tuned to the preload of the coil spring. The coil spring is mounted on the shock absorber between first and second supports. A first support is mounted to a rod extending from the shock absorber body. A second support is mounted about the shock absorber body. On one of the supports is a load sensor for sensing changes in preload of the coil spring. The load sensor communicates with a controller that in turn adjusts the variable dampening mechanism. Adjustment of the variable dampening mechanism maintains the desired relationship between dampening force and coil spring preload.

In one embodiment of this invention, the load sensor is disposed on a first support on the shaft extending from the shock absorber housing. The second support includes threads corresponding to threads on the body of the shock absorber for manual adjustment of coil spring preload. In another embodiment, the load sensor is disposed on the second support positioned on the body of the shock absorber.

The load sensor communicates with the controller either through a wire or through a radio frequency transmitter. In an embodiment of this invention, the controller is an integral part of the shock absorber such that no external connections or wiring are required. When the spring preload is increased by adjusting the coil spring seat, a load sensor on either the upper or the lower supports senses the load change and automatically adjusts the dampening rate of the shock absorber.

Accordingly, the coil over shock assembly of this invention maintains a desired relationship between coil spring preload and dampening properties by adjusting the dampening rate of the shock absorber in relation to changes in coil spring preload.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of a coil over shock absorber assembly;

FIG. 2 is a schematic view of one embodiment of a dampening mechanism;

FIG. 3 is a schematic view of another embodiment of a dampening mechanism; and

FIG. 4 is an alternate embodiment of the coil over shock absorber assembly.

### DETAILED DESCRIPTION OF THE PREFERRED EMBODIMENT

A shock absorber with a coil spring is schematically shown at 10 in FIG. 1. The shock absorber assembly 10 includes a shock absorber 11 with a dampening mechanism 12 disposed within a cylindrical shock absorber body 18. The dampening mechanism 12 is in communication with a controller 26. A shaft 14 extends from within the body 18 and moves relative to the body 18 during operation of the shock absorber 11.

A coil spring 22 is supported about the shock absorber 11 between first and second supports 16 and 20. The first support 16 is positioned on the shaft 14 extending from the body 18. The second support 20 is positioned about the body 18 of the shock absorber 11. The second support 20 is preferably a collar threadingly engaged to threads 28 disposed on the outer surface of the body 18. The second support 20 includes threads 30 engaged to the threads 28 disposed on the body 18 of the shock absorber 11. The shock absorber 11 includes mounting lugs 34 disposed on the body 18 and the shaft 14.

The second support 20 includes a load sensor 24. The load sensor 24 is preferably a linear variable distance transducer forming an integral part of the second support 20. Although preferably a linear variable distance transducer is used to sense the spring preload of the coil spring 22, it is within the contemplation of this invention to use any type of load sensor as is known to a worker knowledgeable in the art. The load sensor 24 is in communication with the controller 26 by way of wire 32. The controller 26 is preferably positioned somewhere within the shock absorber assembly 10 such that the shock absorber assembly 10 is fully self-contained. Although preferably the controller 26 is disposed on the shock absorber assembly 10, it is within the contemplation of this invention that the controller 26 may also be disposed anywhere within the motor vehicle or suspension system to which it is installed.

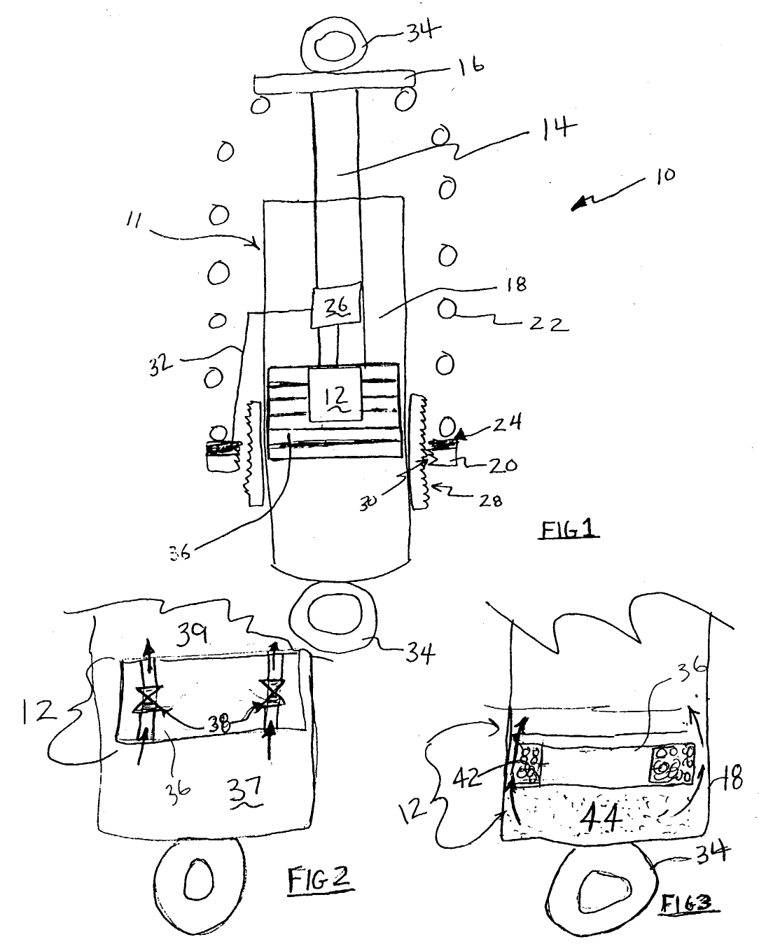

Referring to FIG. 2, an embodiment of the dampening mechanism 12 is schematically illustrated and includes a valve 38 that varies the rate of fluid flow between compartments 37,39 separated by piston 36. Variation of the rate of fluid flow between compartments controls the dampening rate of the shock absorber 11. Preferably hydraulic fluid is used as the dampening medium, however shock absorber assemblies using other types of dampening medium, such as air, would benefit from application of this invention and are within the contemplation of this invention.

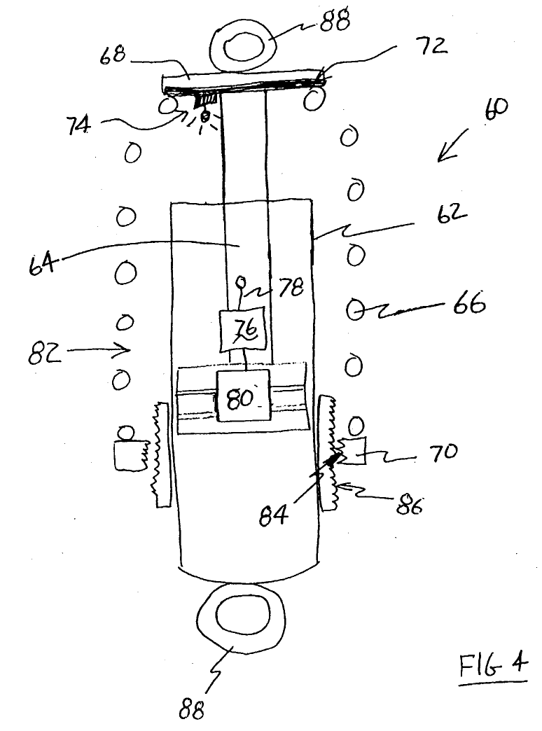

Referring to FIG. 3, in another embodiment of this invention, the dampening mechanism 12 comprises a coil assembly 42 generating a magnetic field to change properties of an electro-reactive fluid 44 disposed within the housing 18. It is within the contemplation of this invention to use electro-reactive, and magna rheological fluids as are well known to a worker skilled in the art.

Referring to FIG. 4, another embodiment of this invention is schematically illustrated and is generally indicated at 60. The shock absorber assembly 60 includes a body 62 and a shaft 64 extending from the body 62. A coil spring 66 is supported on the shock absorber assembly 60 between first and second supports 68, 70. Disposed on the first support 68 is a load sensor 72. The load sensor 72 includes an RF transmitter 74. The RF transmitter 74 communicates with a controller 76 having an antenna 78. The controller 76 actuates the dampening mechanism 80 to change the dampening rate of the shock absorber 82 in response to a change of coil spring preload. The second support 70 includes threads 84 engaged to threads 86. Mounting lugs 88 provide means for mounting the shock absorber assembly 60.

Referring to FIG. 1, in operation, the preload of the coil spring 22 is adjusted by moving the second support 20 by way of mating threads 30,28. Alternatively, a simple increase in weight causes a corresponding increase on the coil spring preload sensed by the load sensor 24 positioned on the second support 20. The change in load sensed by the load sensor 24 is communicated to the controller 26 through wire 32. The controller 26 proportionally actuates the dampening mechanism 12 to change the dampening rate of the shock absorber 11. The change in the dampening rate of the shock absorber 11 optimizes the dampening rate relative to the change in coil spring preload.

Referring to FIG. 4, operation of the shock absorber assembly 60 includes sensing a change in coil preload by the load sensor 72 and transmitting load data by way of the RF transmitter 74. The antenna 78 of the controller 76 receives the load data and adjusts the dampening mechanism 80 relative to the preload of the coil spring 66.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A shock absorber assembly comprising:
a dampening mechanism for varying a dampening rate, said dampening mechanism disposed within said shock absorber;
a shaft extending from within said shock absorber, said shaft including a first support;
a second support disposed on said shock absorber;
a spring disposed between said first and second supports;
a sensor disposed on one of said first and second supports to sense a load exerted by said coil; and
a controller in communication with said dampening mechanism and said sensor for changing said dampening rate in response to a change of said load exerted by said spring.

2. The assembly of claim 1, wherein one of said first and second supports is adjustable to vary said load exerted by said spring.

3. The assembly of claim 2, wherein one of said first and second supports includes threads engaged to threads on said shock absorber.

4. The assembly of claim 1, wherein said dampening mechanism is a valve disposed within said shock absorber, said valve actuatable by said controller to vary dampening properties of said shock absorber.

5. The assembly of claim 1, wherein said shock absorber includes an electro-reactive fluid and said dampening mechanism is a coil actuatable to vary properties of said electro-reactive fluid to vary said dampening rate of said shock absorber.

6. The assembly of claim 1, wherein said controller is positioned on said shock absorber such that said assembly is substantially self-contained.

7. The assembly of claim 1, wherein said spring is a coil spring disposed between said first and second supports.

8. The assembly of claim 7, wherein said coil spring includes a spring rate, said spring rate adjustable by varying a distance between said first and second supports.

9. The assembly of claim 1, wherein said sensor includes a transmitter operating to transmit data indicative of said load exerted by said coil spring to said controller.

10. The assembly of claim 9, wherein said transmitter is a Radio Frequency transmitter.

11. A method of varying dampening properties of a shock absorber assembly comprising the steps of;
a) measuring a force exerted by a spring supported between first and second supports with a sensor disposed on one of said first and second supports;
b) emitting a signal indicative of the force exerted by the spring;
c) receiving the signal indicative of spring force with a controller;
d) adjusting a dampening mechanism in response to said signals indicative of spring force.

12. The method of claim 11, further including the step of adjusting a distance between said first and second supports to vary the force exerted by said spring.

13. The method of claim 11, wherein step d) includes actuating a valve in response to changes in the force exerted by the spring to adjust dampening characteristics of the shock absorber assembly.

14. The method of claim 11, wherein said step d) includes actuating a coil to vary properties of an electro-reactive fluid to adjust dampening characteristics of the shock absorber assembly.

15. The method of claim 11, wherein said step b) includes emitting a signal with an RF transmitter indicative of the force exerted by the spring.
